(19) United States
(12) Patent Application Publication
(10) Pub. No.: US 2004/0257317 A1
(43) Pub. Date: Dec. 23, 2004

(54) Visual display device and a method for superimposing a character on a poster

(76) Inventors: Donal O'Keeffe, Clare (IE); Albert O'Halloran, Clare (IE)

Correspondence Address: SUGHRUE MION, PLLC, 2100 PENNSYLVANIA AVENUE, N.W., SUITE 800, WASHINGTON, DC, 20037, US

(21) Appl. No.: 10/490,547

(22) PCT Filed: Sep. 23, 2002
(86) PCT No.: PCT/IE02/00137

(30) Foreign Application Priority Data
Sep. 24, 2001 (IE) S20010847

(51) Int. Cl. G09G 3/36

(52) U.S. Cl. 345/87

(57) ABSTRACT

A visual display device (1) comprises a housing (4) and a translucent receiving panel (14) for supporting a poster (2) mounted thereon. An viewing aperture (15) is formed in a front wall (5) of the housing (4) for facilitating viewing of the poster (2) therethrough. A liquid crystal visual display panel (18) formed by a matrix of pixels (25) is located in front of the poster (2). The pixels (25) are independently, selectively and alternatively operable in a first light transmitting mode for facilitating viewing of the poster (2) therethrough, and in a second light scattering mode for facilitating display of text (41) superimposed on the poster (2).

The present invention relates to a visual display device, and in particular, to a visual display device for displaying a poster, typically, but not limited to a poster of the size displayed on a billboard, and the invention also relates to a method for displaying the poster with a character or characters forming data superimposed on the poster.

In many cases it is desirable to present information which can be periodically changed in conjunction with a poster, for example, on a billboard poster or the like. For example, the information may be data which is relevant to the poster, such as price data being displayed along with a poster. In such cases it may be desirable to alter the price, if for example a special offer is being made on a specific day, or on a few specific days. Additionally, where a poster relates to an event, and the starting time of the event varies from day to day, it would be desirable to be able to regularly is and rapidly alter the displayed starting time of the event. There are many other cases where it may be desirable to alter certain information and data being displayed with a poster. In general, where it is desired to alter information or data being displayed on or with a poster, it is necessary to stick a separate notice on a part of the poster which contains the variable information. This, is inconvenient, time consuming and expensive.

There is therefore a need for a visual display device which permits at least one character to be displayed along with a poster to be regularly and rapidly alterable. There is also a need for a method for facilitating the superimposing of at least one character on a poster.

The present invention is directed towards providing such a visual display device and a method.

According to the invention there is provided a visual display device comprising a receiving means for receiving a poster, and a screen located in front of the receiving means for facilitating viewing of the poster therethrough wherein the screen is a visual display panel formed by a plurality of pixels arranged in rows and columns to form a pixel matrix, the pixels being selectively and alternately operable in a first light transmitting mode for facilitating viewing of the poster therethrough, and in a second mode for selectively forming and displaying at least one character superimposed on the poster.

In one embodiment of the invention each pixel when operating in the second mode acts with one of the following characteristics:

to scatter light incident thereon and passing therethrough,

to block light incident thereon and passing therethrough,

to absorb light incident thereon,

to reflect light incident thereon, and

to emit light therefrom.

In another embodiment of the invention the pixels are independently addressable.

In another embodiment of the invention the visual display panel comprises an electro-optical medium sandwiched between a pair of substrates, the respective substrates being patterned with column and row electrodes, respectively, for defining the pixel matrix, the column and row electrodes being located for facilitating independent addressing of the pixels for selectively and alternately operating the pixels in their respective first and second modes.

In a further embodiment of the invention the visual display panel is a liquid crystal display panel and the electro-optical medium is a liquid crystal medium. Preferably, the liquid crystal medium is a cholesteric medium.

In one embodiment of the invention the pixels are operable in the second mode in a light scattering or reflecting mode, and preferably, the pixels when operating in the second mode appear to be opaque.

In one embodiment of the invention the pixels when operating in the second mode appear to be white. Alternatively, each pixel when operating in the second mode appears to be coloured.

In another embodiment of the invention at least some of the characters displayed on the visual display panel are alpha or numeric characters for displaying data.

In a further embodiment of the invention the characters displayed on the visual display panel are selectively alterable for selectively altering the displayed data.

In one embodiment of the invention the characters displayed in the visual display panel may be scrolled for scrolling the displayed data, and in another embodiment of the invention at least one of the characters displayed on the visual display panel is a character in the form of a person, animal or article.

In one embodiment of the invention the characters displayed on the visual display panel are in graphics form.

In a further embodiment of the invention at least one of the characters displayed on the visual display panel is animated.

Preferably, an illuminating means for illuminating the poster is provided.

In one embodiment of the invention the illuminating means is located towards the front of the receiving means for illuminating the poster from the front thereof.

In a further embodiment of the invention the illuminating means is located towards the rear of the receiving means for illuminating the poster from the rear thereof. Preferably, the receiving means for receiving the poster is translucent for accommodating light therethrough from the illuminating means for illuminating the poster therethrough.

In one embodiment of the invention the illuminating means comprises a light source.

Additionally, the visual display device comprises the poster and the poster is translucent for facilitating the passage of light through the poster to the visual display panel.

Preferably, the receiving means and the visual display panel are housed in a housing, the visual display panel being spaced apart from the receiving means for accommodating the poster therebetween. Advantageously, a viewing aperture is provided in the housing for viewing the visual display panel and the poster therethrough. Ideally, a protective screen is located in the viewing aperture.

In a further embodiment of the invention a driver circuit is provided in the housing for operating the visual display panel.

Preferably, the illuminating means is housed within the housing.

Additionally the invention provides a method for superimposing at least one character on a poster wherein the method comprises the step of placing a visual display panel in front of the poster, the visual display panel being formed by a plurality of pixels arranged in rows and columns to form a pixel matrix, the pixels being selectively and alternately operable in a first light transmitting mode for facilitating viewing of the poster therethrough, and in a second mode for selectively forming and displaying each character to be superimposed on the poster, and selectively operating selected ones of the pixels in the second mode for forming and displaying the character or characters superimposed on the poster.

In one embodiment of the invention each pixel when operating in the second mode acts with one of the following characteristics:

to scatter light incident thereon and passing therethrough,

to block light incident thereon and passing therethrough,

to absorb light incident thereon,

to reflect light incident thereon, and

to emit light therefrom.

In another embodiment of the invention the characters displayed by the visual display panel are alpha or numeric characters for displaying data.

In another embodiment of the invention the characters are scrolled on the visual display panel for scrolling the data.

In a further embodiment of the invention at least one of the characters displayed in the visual display panel is a person, animal or an article.

In a still further embodiment of the invention the characters displayed on the visual display panel are in the form of graphics.

In a further embodiment of the invention at least one of the characters displayed on the visual display panel is animated.

In another embodiment of the invention the characters displayed on the visual display panel are selectively variable.

Preferably, the poster illuminated, and advantageously, the poster is illuminated from the rear thereof, and light is transmitted through the poster and in turn through the visual display panel. Additionally, or alternatively the poster is illuminated from the front thereof.

The advantages of the invention are many. A particularly important advantage of the invention is that it permits data to be independently displayed along with a poster and superimposed on the poster, and furthermore, it permits the data to be rapidly and regularly altered. A further advantage of the invention is that it permits animated characters to be displayed with a poster, which gives the poster a vibrant look, and tends to attract attention to the poster. Another advantage of the invention is that by virtue of the fact that the characters superimposed on the poster are displayed on a visual display panel, the characters may be alpha-numeric characters to form data, the characters may also be graphics, a person, an animal and/or an article, and may be animated or otherwise, and may be regularly and selectively altered and updated, and furthermore, where data is displayed on the visual display panel the data can be scrolled from top to bottom of the visual display panel or from side to side of the visual display panel. A further advantage of the invention is that it provides an effective dynamic type of display using what is effectively a static poster.

The invention will be more clearly understood from the following description of a preferred embodiment thereof which is given by way of example only with reference to the accompanying drawings in which:

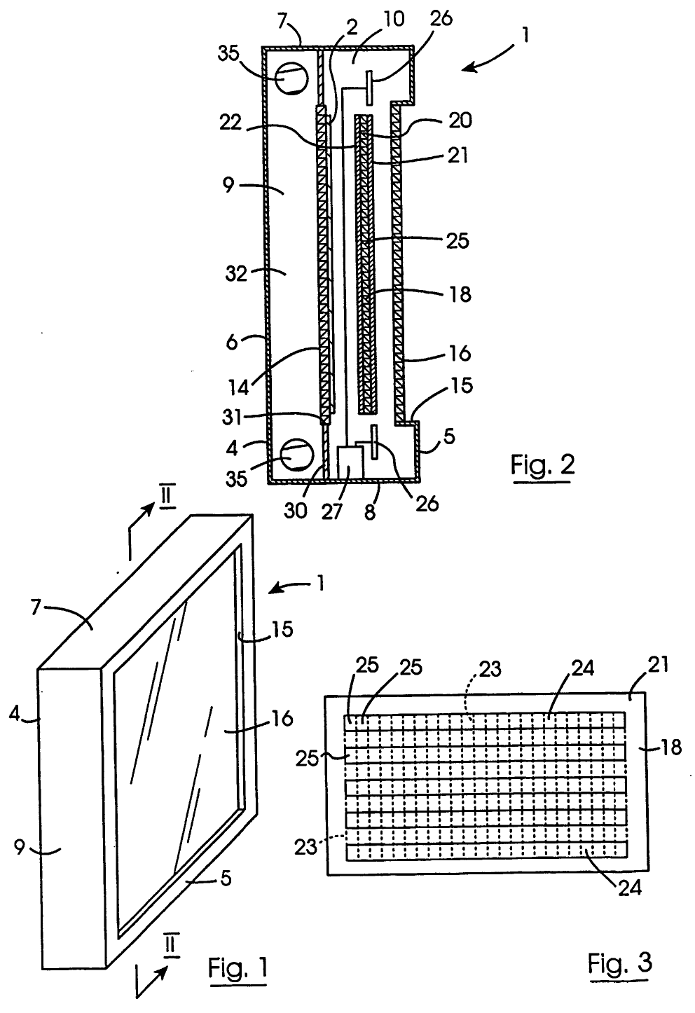

FIG. 1 is a perspective view of a visual display device according to the invention,

FIG. 2 is a transverse cross-sectional side elevational view of the visual display device of FIG. 1 on the line II-II of FIG. 1,

FIG. 3 is a front elevational view of a portion of the visual display device of FIG. 1 (not to scale),

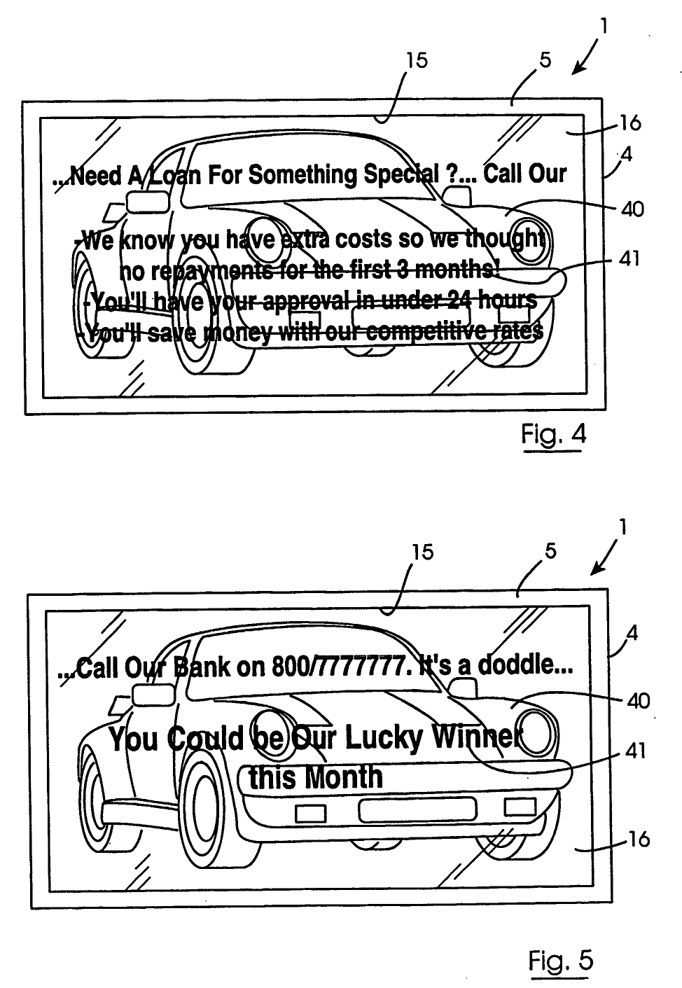

FIG. 4 is a front elevational view of the visual display device of FIG. 1, in use, and,

FIG. 5 is a front elevational view of the visual display device of FIG. 1, also in use.

Referring to the drawings there is illustrated a visual display device according to the invention indicated generally by the reference numeral 1 for displaying a poster 2 typically of the type and size displayed on a conventional billboard, and being of, for example, width 600 mm and height 800 mm, approximately. The visual display device 1 comprises a housing 4 which may be of any suitable material, but in this embodiment of the invention is of plastics material. The housing 4 comprises a front wall 5, a spaced apart rear wall 6, top and bottom walls 7 and 8, respectively extending between the front and rear walls 5 and 6, and side walls 9 extending between the front and rear walls 5 and 6, and the top and bottom walls 7 and 8. The front and rear walls 5 and 6, the top and bottom walls 7 and 8 and the side walls 9 define a hollow interior region 10 within which the poster 2 is supported on a receiving means, namely, receiving panel 14 of light diffusing translucent plastics material. The poster 2 may be secured to the receiving panel 14 by any suitable means, for example, the poster 2 may be laminated to the receiving panel 14 by bonding, or may be secured by clips or other suitable means. A viewing aperture 15 is formed in the front wall 5 for facilitating viewing of the poster 2 therethrough. A protective screen 16 of plastics material is located in the viewing aperture 15.

A visual display panel 18 is mounted by mounting brackets (not shown) within the hollow interior region 10 in front of the receiving panel 14 and the poster 2 for displaying data and information which when viewed through the viewing aperture 15 appears to be superimposed on the poster 2. In this embodiment of the invention the visual display panel 18 comprises an electro-optical medium provided by a cholesteric liquid crystal medium 20 sandwiched between a front substrate 21 and a rear substrate 22 which are patterned respectively with column and row electrodes 23 and 24, respectively, for defining a matrix of pixels 25 arranged in rows and columns of the visual display panel 18. The column and row electrodes 23 and 24 on the front and rear substrates 21 and 22, respectively are independently and selectively addressable for independently, selectively and alternately operating the pixels 25 in a first light transmitting mode for facilitating viewing of the poster therethrough, and in a second light scattering mode for forming alpha-numeric characters for facilitating display of the data and information to be superimposed on the poster 2. Drivers 26 which are illustrated in block representation in FIG. 2 are located within the hollow interior region 10 of the housing 4 for operating the visual display panel 18. Electrically conductive tracks (not shown) formed on the respective front and rear substrates 21 and 22 connect the drivers 26 to the electrodes 23 and 24 for facilitating addressing of the respective pixels 25. The front and rear substrates 21 and 22 are transparent for facilitating viewing of the poster 2 therethrough, and may be of any suitable or desired material, for example, PET plastics material. If necessary transparent reinforcing panels may be provided on respective opposite sides of the visual display panel 18 for strengthening the visual display panel 18. The electrodes 23 and 24 and the electrically conductive tracks (not shown) on the front and rear substrates 21 and 22 are also transparent for facilitating viewing of the poster 2 therethrough.

In practice the visual display panel 18 is located relative to the receiving panel 14 to be relatively close to the poster 2 so that the information displayed on the visual display panel 18 appears clearly to be superimposed on the poster 2.

A programmable control circuit 27 is located in the hollow interior region 10 of the housing 4 for controlling the drivers 26. A microprocessor (not shown) in the control circuit 27 stores the data and information in memory to be displayed on the visual display panel 18, and is programmable for selectively forming appropriate characters for forming and displaying the data and information on the visual display panel 18. The information to be displayed on the visual display panel 18 may be stored in the microprocessor as screens of data, screens of animated displays and/or screens of graphics, which under the control of the microprocessor are displayed selectively and sequentially, and in certain cases, simultaneously. For example, a screen of data may be simultaneously displayed with a screen of graphics, or indeed screens with animated people, animals, articles and the like. An input port (not shown) to the control circuit 27 facilitates inputting the information to be displayed, the sequence in which the screens of information are to be selected, and the time intervals between changes of screens. Additionally, the screens of data, information and other character forms may be updated and their sequence of display may be altered by relaying appropriate control signals to the control circuit 27 over the internet, or through a mobile phone network using Short Message Service (SMS) or Global Packet Radio Service (GPRS) from a central controller, which it is envisaged would control the displays superimposed on the posters on a plurality of remotely located visual display devices. It is envisaged that control signals may be relayed to the control circuit 27 through a wireless network connection, such as bluetooth.

A partition panel 30 extending from the top, bottom and side walls 7, 8 and 9 defines a mounting aperture 31 within which the receiving panel 14 is mounted. The partition panel 30 and the receiving panel 14 define with the rear wall 6 and the top, bottom and side walls 7, 8 and 9 a light box 32. An illuminating means, namely, a pair of fluorescent tubes 35 are located in the light box 32 for illuminating the poster 2 from the rear thereof through the receiving panel 14. The poster 2 is of the type which is also translucent for facilitating the passage of light therethrough through the visual display panel 18 for facilitating viewing of the illuminated poster 2 through the viewing aperture 15. The receiving panel 14 being of a light diffusing material evenly distributes the light from the fluorescent tubes 35 over the poster 2. In this embodiment of the invention when the pixels 25 are operated in the second light scattering mode they scatter the light transmitted through the poster and appear opaque and glow brightly.

Referring now in particular to FIGS. 4 and 5 the poster 2 is illustrated carrying a picture of a motor vehicle 40. In this embodiment of the invention the information which is displayed by the visual display panel 18 and superimposed on the poster 2 is screens of text 41, which are selectively and sequentially displayed under the control of the control circuit 27.

In use with the desired screens of text, graphics and/or animated characters entered and stored in the microprocessor (not shown), and the microprocessor is appropriately programmed to display the screens in the desired sequence for the appropriate time intervals, and a poster secured to the receiving panel 14, the visual display device I is ready for use. Power is supplied to the fluorescent tubes 35, and the microprocessor of the control circuit 27 is activated for sequentially displaying the screens superimposed on the poster.

While the visual display panel has been described as being a liquid crystal display panel comprising a cholesteric medium, any other suitable visual display panel may be used for displaying the information to be superimposed on the poster. For example, the visual display panel may be a Suspended Particular Device, or an Electrochromic Device, both of which when the pixels are operating in the second mode would act to block light passing through the pixels. An alternative visual display panel would be an Organic Light Emitting Diode Panel, which when the pixels are operating in the second mode would act to emit light. Indeed, where the visual display panel is provided by an Organic Light Emitting Diode Panel, the pixels when operating in the second mode would appear coloured, depending on the colour of the light emitted by the pixels when operating in the second mode.

Electrochromic Devices, when the pixels are operating in the second mode absorb light passing therethrough, and thus, pixels operating in the second mode appear dark.

It will also be appreciated that while the visual display device has been illustrated as displaying text superimposed on the poster, any other data or information may be displayed, for example, graphics and the like. Indeed, the graphics may be animated, and may include people, animals and/or articles which may or may not be animated. Furthermore, where text is displayed superimposed on the poster, the text may be scrolled from top to bottom on the visual display panel 18, from side to side or in any other way.

Additionally, while the poster has been described as being illuminated by fluorescent tubes, any other suitable illuminating means may be provided, and indeed, it will be appreciated that the poster may be illuminated from the front, rather than from the rear. Indeed, it is envisaged that the visual display panel may be illuminated independently from the front, or from the rear.

While the visual display panel has been described and illustrated as being of substantially similar size and area to the poster, and to the area of the viewing aperture, it is envisaged that in certain cases the area of the visual display panel may be different to that of the poster, and indeed, may be of a different shape to that of the poster, and/or the viewing area. For example, it is envisaged that in certain cases the visual display panel may be of area which would be smaller, and indeed, in many cases significantly smaller than the poster, and would be of area just sufficient to provide the text or image superimposed on the poster in an area where the text and/or the image is required. It will also of course be appreciated that the visual display panel may be tilted relative to the poster and to the viewing aperture.

It will also be appreciated that while the device has been described as being suitable for displaying a poster of size of the order of 600 mm×800 mm, the device may be provided for displaying posters of other sizes, both larger and smaller, and the visual display device according to the invention is not to be limited by size.

1-38. (Canceled).

39. A visual display device comprising a receiving means (14) for receiving a poster (2), and a screen (18) located in front of the receiving means (14) for facilitating viewing of the poster (2) therethrough characterised in that the screen (18) is a visual display panel (18) formed by a plurality of pixels (25) arranged in rows and columns to form a pixel matrix, the pixels (25) being selectively and alternately operable in a first light transmitting mode for facilitating viewing of the poster (2) therethrough, and in a second mode for selectively forming and displaying at least one character (41) superimposed on the poster (2).

40. A visual display device as claimed in claim 39 characterised in that each pixel (25) when operating in the second mode acts with one of the following characteristics:
to scatter light incident thereon and passing therethrough,
to block light incident thereon and passing therethrough,
to absorb light incident thereon,
to reflect light incident thereon, and
to emit light therefrom.

41. A visual display device as claimed in claim 39 characterised in that the pixels (25) are independently addressable.

42. A visual display device as claimed in claim 39 characterised in that the visual display panel (18) comprises an electro-optical medium (20) sandwiched between a pair of substrates (21,22), the respective substrates (21,22) being patterned with column and row electrodes (23,24), respectively, for defining the pixel matrix, the column and row electrodes being located for facilitating independent addressing of the pixels (25) for selectively and alternately operating the pixels (25) in their respective first and second modes, and preferably, the visual display panel (18) is a liquid crystal display panel and the electro-optical medium is a liquid crystal medium (20), and advantageously, the liquid crystal medium (20) is a cholesteric medium.

43. A visual display device as claimed in claim 39 characterised in that the pixels (25) are operable in the second mode in a light scattering or reflecting mode, and preferably, each pixel (25) when operating in the second mode appears to be opaque, and advantageously, each pixel (25) when operating in the second mode appears to be white.

44. A visual display device as claimed in claim 39 characterised in that each pixel (25) when operating in the second mode appears to be coloured.

45. A visual display device as claimed in claim 39 characterised in that at least some of the characters (41) displayed on the visual display panel (18) are alpha or numeric characters for displaying data, and preferably, the characters (41) displayed on the visual display panel (18) are selectively alterable for selectively altering the displayed data, and advantageously, the characters (41) displayed in the visual display panel (18) may be scrolled for scrolling the displayed data.

46. A visual display device as claimed in claim 39 characterised in that at least one of the characters (41) displayed on the visual display panel (18) is a character in the form of a person, animal or article.

47. A visual display device as claimed in claim 39 characterised in that the characters (41) displayed on the visual display panel (18) are in graphics form, and preferably, at least one of the characters displayed on the visual display panel is animated.

48. A visual display device as claimed in claim 39 characterised in that an illuminating means (35) for illuminating the poster (2) is provided, and in one embodiment the illuminating means (35) is located towards the front of the receiving means (14) for illuminating the poster (2) from the front thereof, and additionally or alternatively, the illuminating means (35) is located towards the rear of the receiving means (14) for illuminating the poster (2) from the rear thereof.

49. A visual display device as claimed in claim 48 characterised in that the receiving means (14) for receiving the poster (2) is translucent for accommodating light therethrough from the illuminating means (35) for illuminating the poster (2) therethrough, and preferably, the illuminating means (35) comprises a light source (35).

50. A visual display device as claimed in claim 48 characterised in that the visual display device (1) comprises the poster (2) and the poster (2) is translucent for facilitating the passage of light through the poster (2) to the visual display panel (18).

51. A visual display device as claimed in claim 39 characterised in that the receiving means (14) and the visual display panel (18) are housed in a housing 4, the visual display panel (18) being spaced apart from the receiving means (14) for accommodating the poster (2) therebetween, and preferably, a viewing aperture (15) is provided in the housing (4) for viewing the visual display panel (18) and the poster (2) therethrough, and advantageously, a protective screen (16) is located in the viewing aperture (15), and preferably, a driver circuit (26) is provided in the housing (4) for operating the visual display panel (18), and advantageously, the illuminating means (35) is housed within the housing (4).

52. A method for superimposing at least one character (41) on a poster (2) characterised in that the method comprises the step of placing a visual display panel (18) in front of the poster (2), the visual display panel (18) being formed by a plurality of pixels (25) arranged in rows and columns to form a pixel matrix, the pixels (25) being selectively and alternately operable in a first light transmitting mode for facilitating viewing of the poster (2) therethrough, and in a second mode for selectively forming and displaying each character (41) to be superimposed on the poster (2), and selectively operating selected ones of the pixels (25) in the second mode for forming and displaying the character or characters superimposed on the poster (2).

53. A method as claimed in claim 52 characterised in that each pixel (25) when operating in the second mode acts with one of the following characteristics:
to scatter light incident thereon and passing therethrough,
to block light incident thereon and passing therethrough,
to absorb light incident thereon,
to reflect light incident thereon, and
to emit light therefrom.

54. A method as claimed in claim 52 characterised in that the characters (41) displayed by the visual display panel (18) are alpha or numeric characters for displaying data, and preferably, the characters (41) are scrolled on the visual display panel (18) for scrolling the data.

55. A method as claimed in claim 52 characterised in that at least one of the characters (41) displayed in the visual display panel (18) is a person, animal or an article, and preferably, the characters (41) displayed on the visual display panel (18) are in the form of graphics, and advantageously, at least one of the characters displayed on the visual display panel (18) is animated.

56. A method as claimed in claim 52 characterised in that the characters (41) displayed on the visual display panel (18) are selectively variable.

57. A method as claimed in claim 41 characterised in that the poster (2) is illuminated, and in one embodiment the poster (2) is illuminated from the rear thereof, and light is transmitted through the poster (2) and in turn through the visual display panel (18), and additionally or alternatively, the poster (2) is illuminated from the front thereof.
